(19) United States
(12) Patent Application Publication
(10) Pub. No.: US 2008/0226104 A1
(43) Pub. Date: Sep. 18, 2008

(54) WIRELESS HANDSFREE DEVICE AND HEARING AID

(76) Inventor: MARK HEDSTROM, Naples, FL (US)

Correspondence Address: Jerry Haynes, Suite 100, 440 Sawgrass Corporate Parkway, Sunrise, FL, 33325, US

(21) Appl. No.: 11/687,520

(22) Filed: Mar. 16, 2007

(51) Int. Cl. H04R 5/02

(52) U.S. Cl. 381/311

(57) ABSTRACT

The present invention relates to a handsfree device capable of enhancing analog audio signals and RF signals for improved hearing comprising: at least one variable gain amplifier which amplify signals transmitted to and from said handsfree device; a CODEC, where said CODEC transmits to and receives signals from said at least on variable amplifier; a RF transceiver, where said RF transceiver receives and transmits RF signals; a digital signal processor, where said digital signal processor transmits commands to the CODEC and RF transceiver; and control commands executed by the digital signal processor, where said control commands transmit functional commands to the both the CODEC and digital signal processor wherein said functional commands include audio shaping and adaptive commands, where said audio shaping and adaptive commands control the transmission of signals via both RF signal sources and ambient analog signal sources.

### CROSS REFERENCE TO RELATED APPLICATIONS

The present application claims priority to U.S. Provisional Patent Application Ser. No., filed Mar. 16, 2006 (entitled “Wireless Device Does Double Duty Providing Cellular Handsfree Operaton and Hearing Aid Function”).

### BACKGROUND OF THE INVENTION

1. Field of the Invention

The present invention relates to a handsfree device that may be advantageously used in conjunction with a cellular phone to amplify signals received from a cellular phone but not used with the cell phone to amplify audio signals as heard by the user.

2. Description of Related Art

Various devices are used to provide wireless communications between a headset or earpiece and a cellular phone. Using a wireless handsfree device with a cell phone many times allows users to use their hands for other tasks while continuing to converse on the cellular phone call.

Some users of wireless devices may need further assistance in amplification of audio signals and therefore may encounter additional problems when using a conventional wireless link. Most users that need audio signal amplification use a hearing aid in order to amplify signals or to filter noise to enable suitable hearing levels. Use of a hearing aid with a cellular phone creates interference and may actually impair the user's hearing. Furthermore, in addition to interference, the sound amplification requirements may not be met when using a conventional hearing aid with a cell phone or a wireless cell phone device.

Presently there are many attempts in the prior art to address problems related to the use of a hearing aid along with a cellular telephone. One such piece of prior art is U.S. Pat. No. 5,721,783 to Anderson which relates to a hearing aid audio communication system. The hearing aid audio system of Anderson provides an auditory aid for hearing impaired persons where the ear piece is used in conjunction with a remote processing unit. The audio signal enhancement functions are therefore removed from the ear piece and placed in this remote processing unit as opposed to having all of its system capabilities within the ear piece. The drawback of the hearing aid system of Anderson is obvious since additional components are necessary to facilitate both the amplification of audio signals and the wireless link to the cellular phone system.

Another hearing aid system for use with cellular phones is disclosed in U.S. Pat. No. 5,768,397 to Fazio. The hearing aid system as disclosed in Fazio includes the insertion of an infrared LED onto a conventional cellular phone again for use in conjunction with an ear piece. As discussed with Anderson, the hearing aid system of Fazio requires additional components and therefore makes the system more electronically cumbersome.

U.S. Pat. No. 6,684,063 to Burger et al. relates to a system that integrates a hearing aid with devices such as wireless telephones which avoids the radio frequency interference as associated with the use of a hearing aid and a cellular phone system. The system as described in Burger however relates to a hearing aid which is integrated into the ear piece of a headset of the cellular phone. Burger is however directed towards avoidance of RF interference and also requires the use of additional components in a wireless application.

The U.S. Patent Application Publication No. 2005/0090295 to Ali et al. relates to a communication headset with signal processing capabilities. The wireless headset as described in Ali includes a means to communicate wirelessly with a signal communication device. Audio signals are converted from a RF signal to a digital signal and the digital signal is then converted to an amplified of audio signal by a CODEC, which is next converted to an acoustical signal by the speaker for input into the ear of the wireless headset user. In the reverse process, outgoing acoustical signals spoken by the user are transmitted to the microphone and sent wirelessly for communication through a cellular telephone. The communication headset disclosed in Ali however fails to provide variable amplification of signals prior to transmission or receipt into the headset system.

A telephone integrated with a hearing aid is described in U.S. Patent Application No. 2004/0001602 to Moo et al. Moo discloses an integrated telephone and hearing aid within a single ear speaker. The system of Moo discloses the integration of a telephone and hearing aid into a single apparatus having a single ear speaker and therefore eliminates the problem of wearing a hearing aid for use with a telephone. Moo fully integrates the phone and hearing aid capabilities but however does not provide a solution for use of the hearing aid solely without use in conjunction with a telephone.

U.S. Patent Application Publication No. 2003/0045283 to Hagedoorn. The Hagedoorn application relates to a link between a hearing aid and a user's wireless telephone that reduces interference between the hearing aid and the telephone. The Hagedoorn application is specifically directed toward using a Bluetooth wireless link as a protocol in order to avoid interference problems. The teachings of Hagedoorn are however directed strictly for use of the hearing aid in conjunction with the wireless telephone and do not address using the hearing aid for audio amplification outside of the telephone wireless link.

U.S. Patent Application Publication No. 2005/0135644 to Qi relates to a digital cell phone with built in hearing aid functionality. Qi discusses the placement of hearing aid functions into a digital cell phone so that a user may use the digital cell phone without the need for a separate hearing aid. Qi places the hearing aid functionality within the cell phone however does not provide the wireless link for the user to use the hearing aid with the cell phone or to receive the audio signals without the cell phone.

The prior art although providing some options to address problems associated with the use of hearing aids and wireless link to cell phones has provided some functionality in the prior art. However some short comings as noted with each of the discussed pieces of prior art have yet to be addressed.

### SUMMARY OF THE INVENTION

The present invention relates to a handsfree device capable of enhancing analog audio signals and RF signals for improved hearing comprising: at least one variable gain amplifier which amplify signals transmitted to and from said handsfree device; a CODEC, where said CODEC transmits to and receives signals from said at least on variable amplifier; a RF transceiver, where said RF transceiver receives and transmits RF signals; a digital signal processor, where said digital signal processor transmits commands to the CODEC and RF transceiver; and control commands executed by the digital signal processor, where said control commands transmit functional commands to the both the CODEC and digital signal processor wherein said functional commands include audio shaping and adaptive commands, where said audio shaping and adaptive commands control the transmission of signals via both RF signal sources and ambient analog signal sources.

In accordance with these and other objects which will become apparent hereinafter, the instant invention will now be described with particular reference to the accompanying drawings.

### BRIEF DESCRIPTION OF THE DRAWINGS

FIG. 1 shows a block diagram of a prior art wireless handsfree device.

FIG. 2 shows a block diagram of a prior art hearing aid device.

FIG. 3 shows a block diagram of a handsfree device with hearing aid capabilities according to the present invention.

FIG. 4 shows an overview of an exemplary embodiment of the present invention.

### DETAILED DESCRIPTION

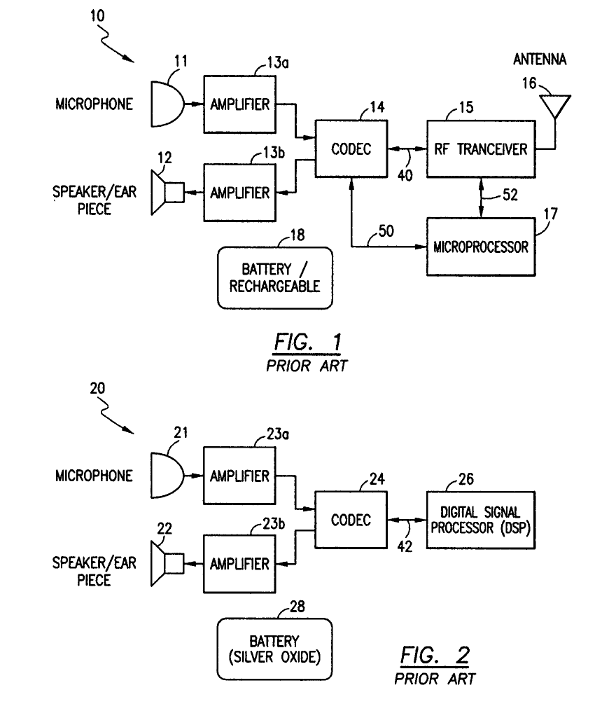

FIG. 1 shows a block diagram of the prior art handsfree device. As depicted in FIG. 1 the prior art wireless handsfree device 10 includes a RF transceiver 15, a microprocessor 17 and a CODEC 14 which make up the primary elements of the prior art handsfree device 10. The handsfree device 10 utilizes a bidirectional wireless link from a cellular device to the RF communications device. The RF transceiver 15 enables various RF interfaces such as Bluetooth, Ultra Wide Band, FM, AM, Zigbee, etc. A microphone 11 of the handsfree device 10 receives an analog signal which is amplified through amplifier 13a before being transmitted through the CODEC 14. The CODEC 14 transforms the analog signal from microphone 11 to a serial data stream. The serial data stream is then transmitted to a cellular phone via the RF transceiver 15. The link 40 designates the path of the serial data stream from CODEC 14 to RF transceiver 15. The RF transceiver 15 transmits the serial data stream via an antenna 16. The transmission of the serial data stream from the CODEC 14 to the RF transceiver 15 onward to the targeted cell phone designates a forward voice link. A reverse voice link signal has a transmission where the signal received by the RF transceiver 15 in the form of a serial data stream is transferred from the CODEC 14 through amplifier 13b to speaker/ear piece 12. The speaker/ear piece 12 therefore receives the audio output from CODEC 14 which is directly fed to a user's ear. Other components depicted in the prior art block diagram FIG. 1 including a battery 18, a microprocessor 17 and command links 50, 52. The microprocessor 17 transmits commands to the CODEC 14 and RF transceiver 15 to provide functional control for the handsfree device 10. The battery 18 supplies power for each component within the handsfree device 10.

FIG. 2 depicts a block diagram of the prior art hearing aid. The digital hearing aid 20 consists of a microphone 21 and transmits a signal for amplification through the amplifier 23a to CODEC 24. The CODEC 24 then transmits a serial data signal to the digital signal processor 26 which then adaptively filters and amplifies the signal in an inverse fashion in order to correct the impaired audio response of the user of the hearing aid 20. The resulting serial data stream from digital signal processor 26 results in an analog output signal from CODEC 24 which is amplified through amplifier 23b and transmitted through speaker/ear piece 22. A signal transmission path 42 is shown between CODEC 24 and DSP 26 where the signals go both directions between the two devices. Although the block diagram of FIG. 2 depicts a digital hearing aid device, comparable analog hearing aid devices include similar functions as described with hearing aid 20. Hearing aid 20 further includes battery 28 which provides power throughout the hearing aid during use.

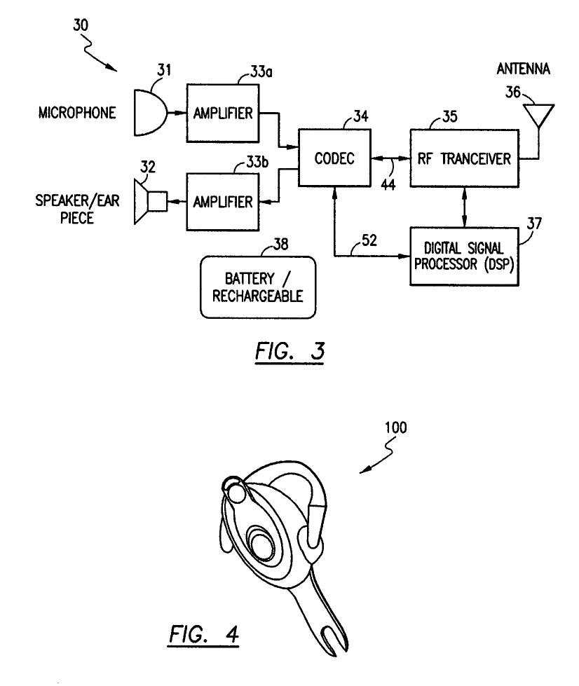

FIG. 3 shows a block diagram of a handsfree device with a hearing aid feature according to the present invention. The handsfree device 30 advantageously includes variable gain amplifiers 33a, 33b. A digital signal processor (DSP) 37 is used in connection with both the CODEC 34 and RF transceiver 35. The DSP 37 replaces the general purpose microprocessor has shown in FIG. 1 with respect to the prior art wireless handsfree device. The DSP 37 therefore performs the functions associated with a prior art general purpose microprocessor in that it can transmit control commands to the CODEC 34 and RF transceiver 35 however the digital processor 37 further includes the capability of audio shaping in order to provide improved hearing response for the user. The audio shaping commands modify both received audio signals through microphone 31 and RF signals from antenna 36. Based on commands received from the DSP 37, the CODEC 34 transmits adaptively filtered signals through variable gain amplifier 33b for the user to receive through speaker/earphone 32. RF signals received through antenna 36 are received by RF transceiver 35 and feed through CODEC 34 to adaptively modify the audio signals. The CODEC 34 then transmits the signal through VGA 33b for further amplification prior to transmission to earpiece 32.

Advantageously the handsfree device 30 may perform the functionality related the handsfree/hearing aid device within a single device. The handsfree device 30 may function solely for handsfree cellular phone operations and may provide improved audio response of the voice signals, when not used in conjunction with a cellular phone as the handsfree device 30, and therefore functions solely as a hearing aid device for the user. The functional commands of the DSP 37 include control commands dictating the flow of signals to and from the DSP 37. Accordingly, the handsfree device may function solely as a hearing aid, as a handsfree communication device solely for cellular phone calls or as a combined device offering simultaneous hearing aid and handsfree functions.

Also as shown in FIG. 3, handsfree device 30 includes a microphone 31 which transmits signals through a variable gain amplifier 33a into CODEC 34 for transmission via the RF transceiver 35 through antenna 36. The CODEC 34 transmits signals via variable gain amplifier 33b for audio transmission through speaker/ear piece 32. The DSP 37 provides the linkage to CODEC 34, link 52, where the DSP includes audio shaping capabilities for the handsfree device 30 in order to improve overall audio transmission to the user. The handsfree device 30 further includes an internal battery 38 which provides power to the various components of handsfree device 30. It is noted that the battery 38 is shown as a rechargeable internal battery in order to eliminate the need for further battery replacements during the life span of handsfree device 30. FIG. 4 shows an overview of an exemplary embodiment of the present invention. A wireless handsfree device 100 is shown in FIG. 4. The handsfree device 100 includes the components as described with respect to FIG. 3.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A handsfree device capable of enhancing analog audio signals and RF signals for improved hearing comprising:
at least one variable gain amplifier which amplify signals transmitted to and from said handsfree device;
a CODEC, where said CODEC transmits to and receives signals from said at least on variable amplifier;
a RF transceiver, where said RF transceiver receives and transmits RF signals from and to the;
a digital signal processor, where said digital signal processor transmits commands to the CODEC and RF transceiver; and
control commands executed by the digital signal processor, where said control commands transmit functional commands to the both the CODEC and digital signal processor wherein said functional commands include audio shaping and adaptive commands, where said audio shaping and adaptive commands control the transmission of signals via both RF signal sources and ambient analog signal sources.

2. The handsfree device according to claim 1, where said functional commands provide improved audio response of analog signal received by a microphone within the handsfree device.

3. The handsfree device according to claim 1 further comprising:
a microphone, said microphone transmits received audio signals into the CODEC via the at least one variable gain amplifier;
an antenna, said antenna transmitting received RF signals into the RF transceiver; and
a speaker/ear piece, said speaker/ear piece receives modified audio signals for the user to hear emitted through said speaker.

4. The handsfree device according to claim 3, further including:
a first variable gain amplifier (VGA), said first VGA receiving signals from the microphone;
a second VGA, said second VGA transmitting signals to said speaker/ear phone;
an input amplification stage occurring within the first VGA; and
an output amplification stage occurring within the second VGA.

5. The handsfree device according to claim 4, wherein said input amplification stage occurs prior to transmission of said signals directly into the CODEC, and said output amplification is applied to modified signals transmitted by the CODEC for the user to hear via the speaker/earphone.

6. The handsfree device according to claim 1, wherein said power supply includes an internal battery.

7. The handsfree device according to claim 6, wherein said internal battery is rechargeable.

8. The handsfree device according to claim 1, where the DSP provides a means for the simultaneous usage of the handsfree device as a hearing aid and a cellular phone earpiece, and provides a means for individual usage of the handsfree device as either a hearing aid or a cellular phone earpiece.
